(19) United States
(12) Patent Application Publication
(10) Pub. No.: US 2004/0200123 A1
(43) Pub. Date: Oct. 14, 2004

(54) Two piece bonded fishing rod blank and fishing rod

(76) Inventor: Kenneth Whiting, Las Vegas, NV (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/787,669

(22) Filed: Feb. 26, 2004

Related U.S. Application Data
(60) Provisional application No. 60/450,497, filed on Feb. 27, 2003.

(51) Int. Cl. A01K 87/00

(52) U.S. Cl. 43/18.5

(57) ABSTRACT

A two-piece bonded fishing rod blank or fishing rod is formed from two filament-wound tubes, or from one filament-wound tube and another tube fabricated by a different process. In the latter case, the tube may be fabricated from sheet-wrap material. In that case, blanks are constructed from two tapered composite tubes and the components are joined together, preferably bonded by applying a thin layer of epoxy to the larger end of the tip section and inserting the tip section, tip first, into the larger end of the butt section. The outer taper of the larger end of the tip section can then be pulled tight against the inside taper of the smaller end of the butt section and allowed to cure. This results in a singular unitized fishing rod blank that exhibits improved hoop strength, increased flexural design parameters, increased sensitivity, and cosmetically appealing surface striations, which are unique and aesthetically pleasing.

### RELATED APPLICATION

This application claims the benefit of priority to U.S. Provisional Patent Application serial No. 60/450,497, filed Feb. 27, 2003.

### FIELD OF THE INVENTION

The present invention relates to graphite fishing rod blanks and more particularly to fishing rod blanks and fishing rods having two pieces fabricated from different types of construction which, when joined together, produce a one piece fishing rod blank or fishing rod with improved hoop strength, increased design flexibility, excellent strength to weight ratio, increased sensitivity, and a cosmetically appealing and unique appearance.

### BACKGROUND OF THE PRESENT INVENTION

Typically, tapered tubular structures used to make fishing rod blanks have been constructed by wrapping multiple layers of unidirectional resin preimpregnated (“prepreg”) fibrous composite sheets, typically comprised of graphite or glass fibers around a tapered mandrel. These layers are typically applied to the mandrel with their fiber orientation being either parallel, perpendicular, or with angularity to the longitudinal axis of the mandrel, or in combination, to achieve the desired design characteristics of a rod or blank as it relates to strength and specific flex points.

Multi directional resin preimpregnated fibrous composite mattes with fiber orientations of 90 degrees, one to the other, or fiber orientations of 45 degrees, one to the other, have also been used to produce rod blanks in order to achieve specific design criteria.

Another method of constructing hollow fishing rod blanks has been the use of non-woven materials as described in U.S. Pat. No. 5,964,056 wherein a non-woven material is used in one or more layers of a multilaminate construction to improve flexibility and hoop strength.

A hollow fishing rod blank produced through the utilization of the filament winding process, when used either by itself or when used in conjunction with the sheet wrap process, exhibits superior characteristics to those produced by the techniques previously mentioned. The filament winding process or the combination of filament winding and sheet wrap as described herein has not previously been used to create a fishing or fishing rod blank.

### SUMMARY OF THE PRESENT INVENTION

The present invention is directed to fishing rod blanks or fishing rods formed with (1) a filament winding technique or (2) a filament winding technique in one section of the rod blank or rod and a different fabrication process in the other. In (1) the rod blank is fabricated wholly by the filament winding technique. Rod blank characteristics such as stiffness and hoop strength are created in the blank by altering the wrap angles along its length, with lower angles to the longitudinal axis being stiffer and higher angles providing improved hoop strength. Another aspect of the present invention relates to hollow, cylindrical rods made by filament winding, wherein the filament-wound material comprises graphite filaments and surface-modified Spectra.

In (2) blanks are constructed from two tapered composite tubes, each utilizing a different fabrication process: sheet wrapping in the tip section and filament winding in the butt section. The two resulting components are then joined together, preferably bonded by applying a thin layer of epoxy to the lower 2.5″ of the larger end of the tip section and inserting the tip section, tip first, into the larger end of the butt section. The outer taper of the larger end of the tip section can then be pulled tight against the inside taper of the smaller end of the butt section and allowed to cure. This results in a singular unitized fishing rod blank that exhibits improved hoop strength, increased flexural design parameters, increased sensitivity, and cosmetically appealing surface striations, which are unique and aesthetically pleasing. The present invention is also directed to fishing rods formed from these blanks.

An improved sheet wrap technique is used in the tip section wherein unidirectional preimpregnated fibrous sheet composites of different moduli are rolled onto a tapered mandrel in a predetermined design pattern. In this way one may use each composites inherent modulus to create an improved tip section with greater design flexibility. The use of multi modulus composite configurations also helps to control rod tip breakage with the inclusion of higher elongation composites at critical locations along the tip section. The modulus of the composites used include fibers in the 30 million modulus range which are higher in elongation, in the 40 million modulus range, which exhibit medium elongation, and the 50 million modulus range and above, which are very light but low in elongation and are extremely stiff and brittle.

In a preferred embodiment, the process used to create the butt section is filament winding. This process involves loading a round tapered mandrel into a filament winding machine and winding a plurality of continuous, pre-wetted graphite filaments at various angles onto the mandrel. Preferably such winding is computer-controlled according to a predetermined design program which is loaded into the filament winding machine computer. When winding is completed the filament wound mandrel is removed from the filament winding machine and placed into a machine which applies a layer of heat constrictive tape to the finished filament wound mandrel. When completed, the filament wound mandrel is removed from the tape machine and placed in an oven for curing.

In one preferred embodiment of the contemplated invention, a butt section is comprised of about 30-60% by weight of resin material and about 40-70% by weight of filaments. Most preferably the butt section would be comprised of about 40-50% resin material preferably from the oxirane group of epoxies and about 50-60% graphite filaments of a modulus between 30 and 80 million. Other fibers such as Kevlar, liquid crystal polymers, polyesters, Ultrahighdensity polyethylene (e.g. Spectra), “E” or “S” glass, and various other now unknown Hybrid fibers similar in modulus may be added in alternative embodiments.

Filament winding is not known to have been incorporated into the construction of a fishing rod blank or fishing rod, but the process is such that it can be varied to provide improved and virtually unlimited performance characteristics. For example by varying the particular type or types of filaments or the filament bundle size, the number of passes or windings, or the angle at which the filaments are laid, either throughout the entire length of the butt section or at specified locations along the butt section, the characteristics of the butt section can be changed. The particular winding angle can also be varied at one or more selected locations along the length of the butt section to provide desired flexural or performance characteristics. Butt sections fabricated using this process exhibit extremely high strength to weight ratios, reducing blank weight by as much as 40% in areas of utilization, outstanding hoop strength, improved casting distances of up to 20%, increased sensitivity, and improved control over the rod once a fish has been hooked.

The resulting tapered tubular structure of the present invention, whether one-piece or unitized, does in fact provide for an improved fishing rod blank or rods that are highly functional and have unique and cosmetically pleasing appearances, unobtainable by way of conventional construction methods.

### BRIEF DESCRIPTION OF THE FIGURES

FIG. 1 is a longitudinal section showing the connection between the sheet wrapped tip section and the filament wound butt section.

FIG. 2 is a plan view of a prepreg sheet ready to be wrapped on a mandrel.

FIG. 2(a) is a plan view of a second prepreg sheet ready to be wrapped on the mandrel containing the wrapped prepreg sheet from FIG. 2.

FIG. 2(b) is a plan view of a third prepreg sheet to be wrapped on the mandrel containing the previously wrapped sheets from FIGS. 2 and 2(a).

FIG. 3 is a fragmentary view of a portion of the butt section of the fishing rod blank showing the filaments wound onto the mandrel and illustrating the angle of application of such filaments relative to the mandrel axis.

FIG. 4 is a perspective view of a portion of the fishing rod blank at the area of the splice between the tip section and the butt section.

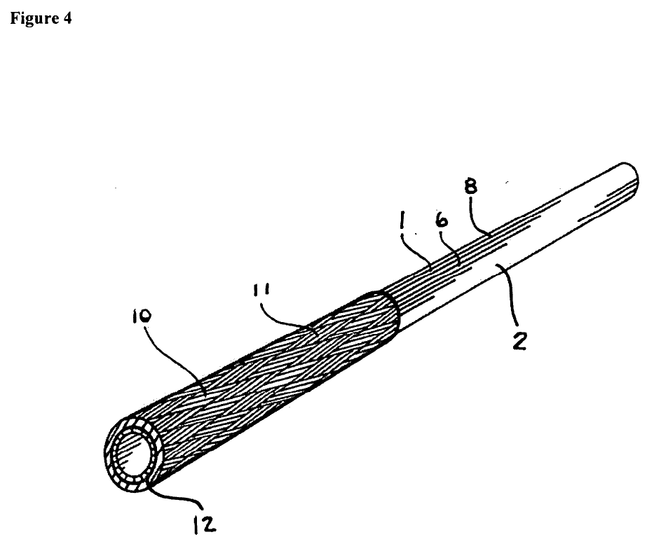

### DETAILED DESCRIPTION OF SPECIFIC EMBODIMENTS

A fishing rod blank and a method of manufacturing the rod blank according to the present invention will be described in detail hereinafter, with reference to the drawings. These examples are not intended to be construed in a limiting sense.

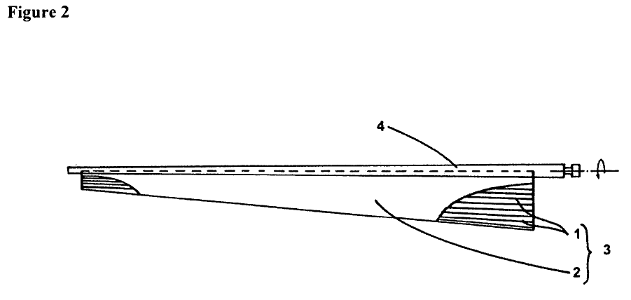

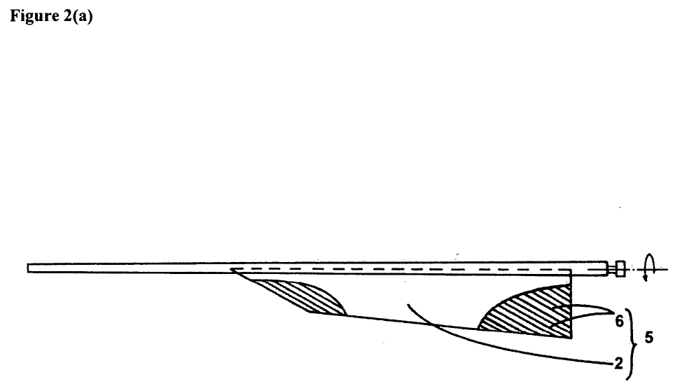

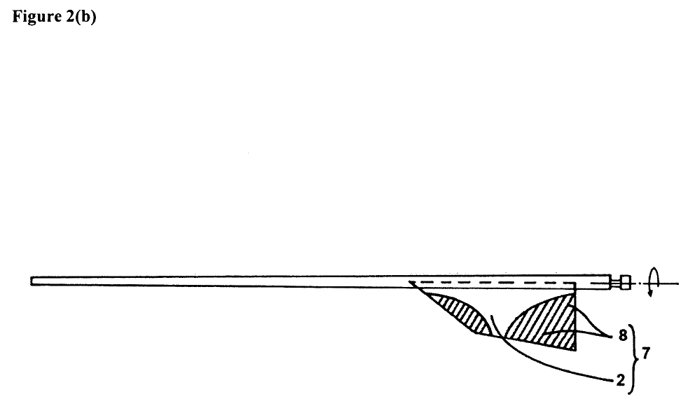

As shown in FIG. 2 a prepreg sheet 3 is formed with graphite fibers 1 oriented axially of the tip section and impregnated with a resin 2. The prepreg sheet 3 has a width extending over an entire length of the tip section. The prepreg sheet 3 is wound in one to three piles on a mandrel 4 having a forward end about 0.5 to 1.0 mm. in diameter. FIG. 2(a) shows a prepreg sheet, of a different modulus, 5 with graphite fibers 6 oriented on a bias at angles ranging from 23 to 45 degrees to the axis of the mandrel and impregnated with a resin 2, and wrapped over the prepreg sheet or sheets wound onto the mandrel in FIG. 2.

The prepreg sheet 5 has a width extending over 50 to 80% of the entire length of the tip section. FIG. 2(b) shows a prepreg sheet, of another different modulus, 7 with graphite fibers 8 oriented in a reverse bias to the fibers in FIG. 2(a) and just off perpendicular or between 60 and 80 degrees to the axis of the mandrel, impregnated with a resin 2. The sheet in FIG. 2(b) is wound over the preceding sheets wound onto the mandrel in FIGS. 2 and 2(a). The prepreg sheet 7 has a width extending over 20 to 50% of the entire length of the tip section. A heat-constrictive tape (not shown) is wound around the completed mandrel as formed above, and then heat cured in an oven to form the tip section.

Various other fibers or combination of resin impregnated fibers may be added to the graphite fibers for forming the tip section, such as Kevlar, olyester, liquid crystal polymer, and “E” or “S” glass, depending on the specific design criteria required of the tip section.

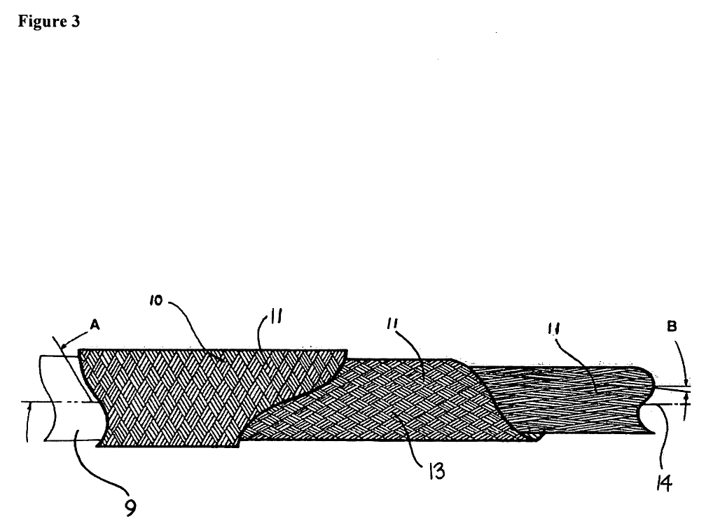

FIG. 3 relates principally to the filament winding process utilized in constructing the butt section of the present invention. All figures, however, facilitate an understanding of the processes involved in creating the present invention. The butt section of the present invention in the preferred embodiment is comprised of a resin 10 with a plurality of elongated graphite filaments 11 spirally wound on a tapered mandrel and imbedded with a resin 10. The present invention is not intended to be limited to any particular resin material, however it should be sufficient to provide the desired strength, weight and flexural characteristics of the completed fishing rod blank, of the present invention. In the most preferable embodiment, the resin material is a thermoset epoxy resin which contains the oxirane group. This epoxy group is reactive with a wide range of curing agents or hardeners, which are known to those skilled in the art.

The spiral winding of the filaments in accordance with the present invention contemplates a plurality of filaments applied by spiral winding to the mandrel at an incline angle relative to its longitudinal axis. For example as illustrated in FIG. 3 some of the graphite fibers 11 are laid down on the mandrel at an angle “A”, while some of the graphite filaments 11 are laid down on the mandrel at an angle “B”, while yet other graphite filaments 11 may be laid down on the mandrel at any number of different angles 13. The angles “A”, “B” and 13 which the graphite filaments 11 form with the longitudinal axis 14 of the butt section, will depend principally upon the rotational speed of a center mandrel and the transitional speed of a filament dispenser carriage.

The particular number of winding passes of the filaments and the particular angle at which the filaments are laid on the mandrel is a function of the desired characteristics of the butt section. Using graphite fibers as provided in a preferred embodiment, between 10 and 20 filament passes with a filament angle of between 5 degrees to 15 degrees followed by 1 to 5 passes at angles between 30 degrees and 50 degrees are suitable to achieve the desired characteristics of the butt section.

It has been found that the winding of the filaments at a relatively shallow angles provide for improved stiffness, while windings at a greater angle will improve hoop strength. Accordingly even greater hoop strength is achieved when the windings of greater angles are laid down on the final passes. In the most preferred embodiment, graphite filaments having approximately 6,000 to 14,000 fibers per bundle are utilized. As an alternative, certain other filaments or filament combinations including liquid crystal, metallic, aramid, Ultrahighdensity polyethylene (e.g. Spectra), “E” or “S” glass and various other now unknown hybrids similar in modulus may be utilized.

The butt section of the present invention is advantageously constructed of a combination of resin 10 and graphite filaments 11 that provide a finished butt section weight of between 15 and 30 grams. Of the weight, preferably 30 to 60% by weight and most preferably 40 to 50% by weight is resin 10 and preferably about 40 to 70% by weight and most preferably 50 to 60% by weight is comprised of graphite filaments 11. Regardless of the number of windings or bundle size of the graphite filaments 11, the total weight of filaments in the butt section should be about 8 to 15 grams. The resulting filament wound tapered mandrel is then wrapped with a contractive tape and placed in an oven for curing.

In certain preferred embodiments, the graphite filament shells may be obtained from Aerotech Corporation of Bellingham, Wash., as product numbers AM-360, AM-325, and AM-280, as appropriate.

Following the curing of the sheet wrapped tip section and the filament wound butt section, the contractive tape is removed from each. Following this, the mandrels are extracted from each on a mandrel pulling machine. The resulting tapered tubular tip sections and butt sections are then cleaned up by trimming the ends and passing them through a centerless grinder to removed burrs, flashes or surface imperfections resulting from the application of the contractive tape.

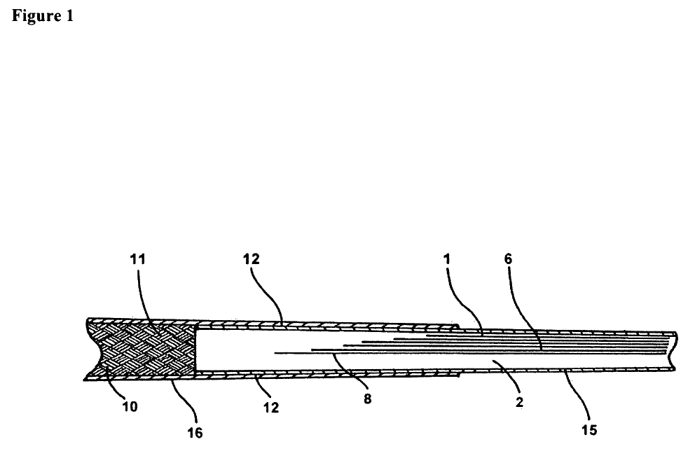

Upon completion of the clean-up procedure a thermoset or two part epoxy, of a sufficient strength to provide for adequate bonding between the tip section 15 and the butt section 16, is applied circumferentially to a 2.5″ portion of the tip section along the bonding line 12 in FIG. 1. The tip section 15 is then inserted into the butt section 16 and pulled tight against one another. Accordingly the tip section 15 self centers because the exterior taper of tip section 15 and the interior taper of the butt section are the same in the area of the splice. The splice joint is then allowed to cure accordingly with the requirements of the epoxy used to bond the splice.

The result is a singular, unitized fishing rod blank that can be used to manufacture casting, spinning and fly rods, both freshwater and saltwater that exhibit improved hoop strength, increased flexural strength and that is cosmetically appealing do to surface striations resulting from the filament winding process which are unique and aesthetically pleasing.

Another aspect of the present invention relates to filament wound compositions, wherein the filament would material comprises graphite and surface-modified Spectra. The surface modification procedure enhances the ability of the Spectra fibers to bond to the graphite fibers. Filament wound materials comprising graphite and surface-modified Spectra have superior properties compared to compositions made from graphite and Spectra, wherein the Spectra has not be surface modified. For example, filament wound rods made from graphite and Spectra that has not been surface modified can be permanently deformed when bent. In contrast, when a weight is applied to rods made from filament wound material comprising graphite and surface-modified Spectra, the rod will bend under the stress, but the rod will return to its original straight form once the weight is removed.

General Procedure for Surface Modification of Spectra

The surface of Spectra particles can be modified using the procedures described in U.S. Pat. No. 4,880,879, which is hereby incorporated by reference. The high molecular weight polyethylene particles, e.g., Spectra, can be treated by a wide variety of methods which are capable of increasing the surface tension to the required level since only the resultant surface tension and not the method of treatment is critical. In certain embodiments, the surface tension of the treated high molecular weight polyethylene particles is at least about 25, 30, or 40 dynes/cm. Such treatments include exposure to a fluorine-containing gas, a plasma of an inorganic gas, sulfur trioxide, halogens, oxidative acids, ionizing radiation, ultraviolet light, peroxides, ozone, surfactants and corona treatment. Surface treatment of the high molecular weight polyethylene particles can be carried out batch-wise or in a continuous process at conditions of time, temperature and pressure which are best suited for the particular type of treatment used.

In certain embodiments, the surface treatment should increase the surface tension of the polyethylene particles to ensure sufficient bonding of the particles to the polymeric material to prevent the particles from “popping out” of the composite during use. Since the surface tension of fine particles cannot be measured directly, measurements for the present invention were made by molding small test plaques; e.g. about 4 cm², from the same polyethylene resin and included with the particles during treatment. See U.S. Pat. No. 4,880,879 for an example of surface modification of a high molecular weight polyethylene.

Definitions

The term “filament-wound section” refers to a hollow rod formed by the filament winding technique.

The term “sheet-wrap material” refers to a hollow rod formed by the sheet-wrap technique.

I claim:

1. A fishing rod blank comprising a filament-wound section.

2. The blank of claim 1, wherein said blank comprises a first section and a second section; said first section is filament wound; and said second section is a non-filament-wound material.

3. The blank of claim 2, wherein said second section is wood, plastic, or sheet-wrap material.

4. The blank of claim 2, wherein said second section is sheet-wrap material.

5. The blank of claim 2, wherein said second section is sheet-wrap material, said second section forms the tip of said blank, and said first section forms the butt section of said blank.

6. The blank of claim 2, wherein said first section comprises about 30% to about 60% by weight resin material and about 40% to about 70% by weight filaments, such that the sum of the weight percents of the resin and filaments equals 100 weight percent.

7. The blank of claim 2, wherein said first section comprises about 40 to about 50% by weight resin material and about 50 to about 60% by weight filaments, such that the sum of the weight percents from the resin and filaments equals 100 weight percent.

8. The blank of claim 2, wherein said first section comprises a thermoset epoxy resin that contains an oxirane group.

9. The blank of claim 2, wherein said first section comprises graphite filaments that have a modulus of about 30 million to about 80 million.

10. The blank of claim 2, wherein said first section comprises graphite filaments that about 6,000 to about 14,000 fibers per bundle.

11. The blank of claim 2, wherein said first section comprises graphite filaments and surface-modified Spectra.

12. The blank of claim 2, wherein said second section is sheet-wrap material comprising graphite filaments.

13. The method of claim 2, wherein said second section is sheet-wrap material, and said sheet wrap material comprises graphite filaments and Kevlar.

14. The blank of claim 2, wherein said second section is sheet-wrap material comprising graphite filaments that have a modulus of about 30 million to about 50 million.

15. A method of making a fishing rod blank, comprising the step of
attaching a first section to a second section, wherein said first section is filament wound, and said second section said section is a non-filament wound material.

16. The method of claim 15, wherein said first section comprises graphite filaments that have a modulus of about 30 million to about 80 million.

17. The method of claim 15, wherein said first section comprises graphite filaments that have about 6,000 to about 14,000 fibers per bundle.

18. The method of claim 15, wherein said first section comprises graphite filaments and surface-modified Spectra.

19. The method of claim 15, wherein said second section is wood, plastic, or sheet-wrap material.

20. The method of claim 15, wherein said second section is sheet-wrap material.

21. The method of claim 15, wherein said second section is sheet-wrap material, and said sheet wrap material comprises graphite filaments.

22. The method of claim 15, wherein said second section is sheet-wrap material, and said sheet wrap material comprises graphite filaments and Kevlar.

23. A hollow tube comprising a filament wound section, wherein said filament wound section comprises graphite filaments and surface-modified Spectra.

24. The tube of claim 23, wherein said graphite filaments have a modulus of about 30 million to about 80 million.

25. The tube of claim 23, wherein said graphite filaments have about 6,000 to about 14,000 fibers per bundle.

26. The tube of claim 23, wherein said Spectra has been surface-modified by a fluorine-containing gas.
